(19) United States
(12) Patent Application Publication
(10) Pub. No.: US 2025/0350068 A1
(43) Pub. Date: Nov. 13, 2025

(54) CONNECTOR

(71) Applicant: UNIQCONN INC., Seongnam-si (KR)

(72) Inventors: Young Dong KIM, Hwaseong-si (KR); Yong Hun OH, Osan-si (KR); Joung Min PARK, Osan-si (KR); Jong Hyup LIM, Hwaseong-si (KR)

(73) Assignee: UNIQCONN INC., Seongnam-si, Gyeonggi-do (KR)

(21) Appl. No.: 19/196,907

(22) Filed: May 2, 2025

(30) Foreign Application Priority Data
May 7, 2024 (KR) 10-2024-0060116

(51) Int. Cl. H01R 13/6581

(52) U.S. Cl. CPC H01R 13/6581; H01R 2201/02

(57) ABSTRACT

The present disclosure relates to a connector. According to one embodiment of the present disclosure, a connector, which is coupled to an antenna for transmitting or receiving a wireless signal and a signal line unit for transmitting the wireless signal, includes a connector body including a first sidewall portion, a second sidewall portion, and a third sidewall portion, wherein the first sidewall portion surrounds a space that accommodates the antenna, the second sidewall portion guides the wireless signal propagated between the antenna and the signal line unit, the third sidewall portion is in contact with a portion of the signal line unit, and spaces surrounded by each of the first sidewall portion, the second sidewall portion, and the third sidewall portion communicate with each other.

### CROSS-REFERENCE TO RELATED APPLICATION

This application claims priority to and the benefit of Korean Patent Application No. 10-2024-0060116, filed on May 7, 2024, the disclosure of which is incorporated herein by reference in its entirety.

### BACKGROUND

### 1. Field of the Invention

The present disclosure relates to a connector, and more particularly, to a connector coupled to an antenna for transmitting or receiving wireless signals and a signal line unit for transmitting wireless signals.

### 2. Discussion of Related Art

The manufacturing costs of communication devices that transmit wireless signals through dielectrics are less expensive than that of coaxial cables that transmit wired signals through conductors, and the communication devices are easy to perform impedance matching with connectors. Further, the installation and management of the communication devices that transmit wireless signals through dielectrics are easier than those of optical communication lines, and thus the communication devices may be efficiently utilized for chip-to-chip communication.

These communication devices consist of signal line units and connectors. The signal line unit transmits various signals through dielectrics, and the connector fixes the signal line unit. The connector is coupled to a portion that transmits or receives various signals. In this case, in order to stably transmit signals between a signal transmission/reception unit and the signal line unit, the connector should firmly fix the signal line unit.

However, there is a problem that conventional connectors are not firmly coupled to a signal line unit. In this case, a space is formed between the connector and the signal line unit, and a discontinuous section may occur due to various characteristics of the transmitted signal. Accordingly, when the conventional connector is used, the intensity of the transmitted signal may be unstable or noise may occur. Further, problems, in which interference may occur in the signal transmitted between the connector and the signal line unit due to other external signals, and conversely, the signal transmitted between the connector and the signal line unit is radiated to the outside, and accordingly, the transmission efficiency can be reduced, may occur.

Further, when the conventional connector is used, there is a problem in that when wireless signals radiated from an antenna, which is an example of a signal transmission/reception unit, are transmitted toward a signal line unit, the transmitted wireless signal spreads in various directions and thus the gain of the wireless signal is reduced. In this case, a separate amplifier should be placed to improve the gain of the wireless signal, and thus space efficiency can be reduced and the installation of the communication device can be complicated.

Accordingly, there is an urgent necessity to develop a connector that is simply connected to a signal line unit, firmly fixes the signal line unit, and can prevent signal gain from being reduced.

Meanwhile, the above-described related art is technical information that the inventor possessed for deriving the present disclosure or acquired during the process of deriving the present disclosure and cannot necessarily be considered as publicly known technology disclosed to the general public prior to the application of the present disclosure.

### RELATED ART DOCUMENT

### Patent Document

(Patent Document 1) Korean Laid-open Patent Publication No. 10-2010-0032769 (Mar. 26, 2010)

### SUMMARY OF THE INVENTION

The present disclosure is directed to providing a connector including a connector body for providing a space through which wireless signals are propagated, which is capable of guiding the wireless signal between an antenna and a signal line unit.

The present disclosure also is directed to providing a connector that is easy to assemble by allowing a connector body, an insert member, and a housing to be easily coupled.

The present disclosure also is directed to providing a connector capable of preventing rotation or movement of a signal line unit by allowing each component thereof to be coupled to the signal line unit.

The present disclosure also is directed to providing a connector capable of increasing transmission efficiency of wireless signals transmitted between an antenna and a signal line unit by arranging an insert member inside a connector body.

Objects of the present disclosure are not limited to the above-described object and other objects that are not described may be clearly understood by those skilled in the art from the following descriptions.

According to an aspect of the present disclosure, there is provided a connector that is coupled to an antenna for transmitting or receiving a wireless signal and a signal line unit for transmitting the wireless signal, which includes a connector body including a first sidewall portion, a second sidewall portion, and a third sidewall portion, wherein the first sidewall portion surrounds a space that accommodates the antenna, the second sidewall portion guides the wireless signal propagated between the antenna and the signal line unit, the third sidewall portion is in contact with a portion of the signal line unit, and spaces surrounded by each of the first sidewall portion, the second sidewall portion, and the third sidewall portion communicate with each other.

The signal line unit may include a core that extends in a longitudinal direction, a shield portion that is spaced apart from the core, surrounds the core, and extends in the longitudinal direction, and at least one rib that extends from an outer circumferential surface of the core toward an inner circumferential surface of the shield portion.

The third sidewall portion may include at least one second rib insertion groove that is recessed in the longitudinal direction, and at least a portion of the at least one rib may be inserted into the at least one second rib insertion groove.

The connector may further include an insert member disposed in the space surrounded by the second sidewall portion, wherein the insert member may include a first structure including a horn shape on which at least one inclined portion is formed, a second structure that extends in the longitudinal direction from an end portion of the first structure, and a third structure that extends in the longitudinal direction from an end portion of the second structure, and the first structure, the second structure, and the third structure may share a central axis.

The second sidewall portion may include a first protrusion that protrudes from an inner surface of the second sidewall portion toward the second structure.

The third structure may include a core insertion groove formed in a central region of one surface of the third structure, and a portion of the core may be inserted into the core insertion groove.

The third structure may include a core insertion protrusion that protrudes from a center of the core insertion groove, and the core insertion protrusion may be inserted into a central hole inside the core formed in the longitudinal direction.

The third structure may include at least one first rib insertion groove that is radially recessed from a center of one surface of the third structure, and at least a portion of the at least one rib may be inserted into the at least one first rib insertion groove.

The second structure and the third structure may include a plurality of through-holes formed to pass therethrough in the longitudinal direction, and the plurality of through-holes may be spaced a predetermined interval or more from a central axis of the insert member and radially disposed based on the central axis of the insert member.

The connector body may include a first step formed between the second sidewall portion and the third sidewall portion, and the insert member may include a second step that is formed between the second structure and the third structure and corresponds to the first step.

The connector may further include a housing coupled to the connector body, wherein the housing may include a first coupling portion formed on an inner circumferential surface of the housing, and a shield portion fixing portion that extends in the longitudinal direction from the first coupling portion.

The second sidewall portion may include a second coupling portion formed on an outer side of the second sidewall portion, and the first coupling portion and the second coupling portion may include screw threads corresponding to each other.

The third sidewall portion may include a second protrusion that protrudes from an outer circumferential surface of the third sidewall portion toward the signal line unit, and a portion of the shield portion may be disposed in a space formed between the third sidewall portion and the shield portion fixing portion.

A direction in which the at least one rib extends from the outer circumferential surface of the core may form an angle of 45° with respect to a horizontal polarization direction or vertical polarization direction of the wireless signal propagated between the antenna and the signal line unit.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a perspective view of a communication device in which a connector and a signal line unit are connected according to one embodiment of the present disclosure;

FIG. 2 is an exploded perspective view of a connector according to one embodiment of the present disclosure;

FIG. 3 is a cross-sectional view of a connector body that accommodates an antenna according to one embodiment of the present disclosure;

FIG. 4 is a cross-sectional view of a connector body that accommodates an antenna and an insert member according to one embodiment of the present disclosure;

FIG. 5 is a cross-sectional view of a connector body that accommodates an antenna, an insert member, and a portion of a signal line unit according to one embodiment of the present disclosure;

FIG. 6 is a perspective view for describing a connection of a connector and a signal line unit according to one embodiment of the present disclosure;

FIG. 7 is a perspective view of an insert member according to another embodiment of the present disclosure; and

FIG. 8 is a perspective view of an insert member according to still another embodiment of the present disclosure.

### DETAILED DESCRIPTION OF EXEMPLARY EMBODIMENTS

Advantages and features of the present disclosure and methods of achieving the same will be clearly understood with reference to the accompanying drawings and embodiments described in detail below. However, the present disclosure is not limited to the embodiments disclosed below but may be implemented in various different forms. The embodiments are provided in order to fully explain the present disclosure and fully explain the scope of the present disclosure for those skilled in the art. That is, the scope of the present embodiments is only defined by the appended claims.

The shapes, sizes, ratios, angles, or numbers disclosed in the drawings for describing the embodiments of the present disclosure are exemplary, and therefore, the present disclosure is not limited to the matters illustrated. Further, in description of the present disclosure, when it is determined that detailed descriptions of related well-known functions or configurations may unnecessarily obscure the gist of the present disclosure, detailed descriptions thereof will be omitted. Further, when the terms “include,” “have,” “consist of,” etc., are used in this specification, another portion may be added unless “only” is used. When a component is expressed in the singular form, it includes a case where it includes a plural form unless the context clearly indicates otherwise.

In interpretation of components, it is interpreted as including a range of errors even when there is no separate explicit description. For example, unless otherwise explicitly stated, the term “same” does not mean exactly the same, but rather “substantially the same” within a range of error that those skilled in the art may reasonably expect to encounter in practicing the present disclosure.

It should be understood that, although the terms “first,” “second,” etc., may be used herein to describe various components, these components are not limited by these terms. The terms are only used to distinguish one component from another component. Therefore, it should be understood that a first component to be described below may be a second component within the technical scope of the present disclosure.

Unless otherwise specified, like reference numerals refer to like elements throughout the specification.

The individual features of the various embodiments of the present disclosure may be partially or entirely connected or combined with each other, and as can be fully understood by those skilled in the art, various technical connections and operations are possible, and each embodiment may be implemented independently of each other or may be implemented together in a related relationship.

In the present disclosure, when a plurality of components are connected, it should be understood that the respective components may be connected not only directly to each other, but also indirectly. Therefore, when the plurality of components are connected to each other, another component may be connected between the plurality of components.

In description of various embodiments of the present disclosure, when some configuration of an embodiment is substantially the same as or corresponding to some configuration of another embodiment described above, the description of that configuration may be omitted for a clear and concise description of the present disclosure. Further, when some configurations have a structure that is symmetrical with other configurations, for example, a structure with axial symmetry or rotational symmetry, so that both configurations are substantially the same configuration with only a difference in direction or location, the description of the configuration may be omitted for the sake of a clear and concise description of the present disclosure, unless it is necessary to specify the present disclosure.

Hereinafter, terms used in this specification will be described.

Guiding a wireless signal is to adjust a propagating direction of a wireless signal by utilizing an interface between a first material through which the wireless signal is propagated and a second material different from the first material. Here, the first material and the second material may be a dielectric or a conductor.

Hereinafter, the present disclosure will be described in detail with reference to the accompanying drawings.

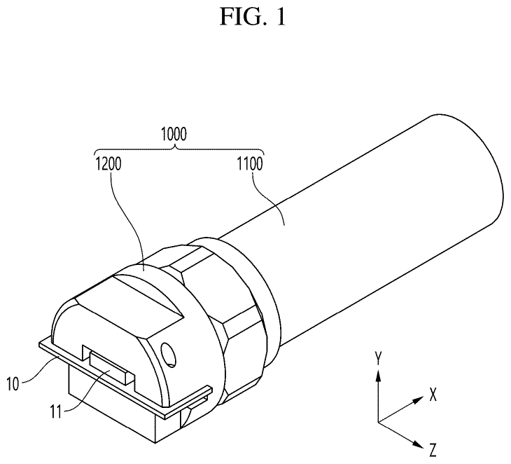

FIG. 1 is a perspective view of a communication device in which a connector and a signal line unit are connected according to one embodiment of the present disclosure.

First, referring to FIG. 1, a communication device 1000 includes a signal line unit 1100 that transmits wireless signals and a connector 1200. Further, an antenna 11 that transmits or receives wireless signals may be coupled to one side of the communication device 1000.

The communication device 1000 may transmit a wireless signal generated on one side to the other side, or transmit a wireless signal generated on the other side to one side. Specifically, the communication device 1000 may transmit a wireless signal propagated to the other side of the signal line unit 1100 to the antenna 11 accommodated in one side of the connector 1200. Further, the communication device 1000 may transmit a wireless signal radiated from the antenna 11 to the other side of the signal line unit 1100. That is, the communication device 1000 may transmit a wireless signal in both directions.

Meanwhile, the communication device 1000 may include various numbers of signal line units 1100 or connectors 1200. For example, the communication device 1000 may include a signal line unit 1100 and two identical connectors 1200 coupled to both sides of the signal line unit 1100. In this case, the communication device may transmit a wireless signal radiated from an antenna 11 accommodated in one side of the connector 1200 to an antenna accommodated in the other side of the connector (not illustrated) or vice versa. That is, the communication device 1000 may perform wireless signal transmission in both directions. In this case, the communication device 1000 may transmit a wireless signal generated in one semiconductor chip to another semiconductor chip connected to the antenna on the other side through an antenna or vice versa. That is, the communication device 1000 may be utilized for chip-to-chip communication.

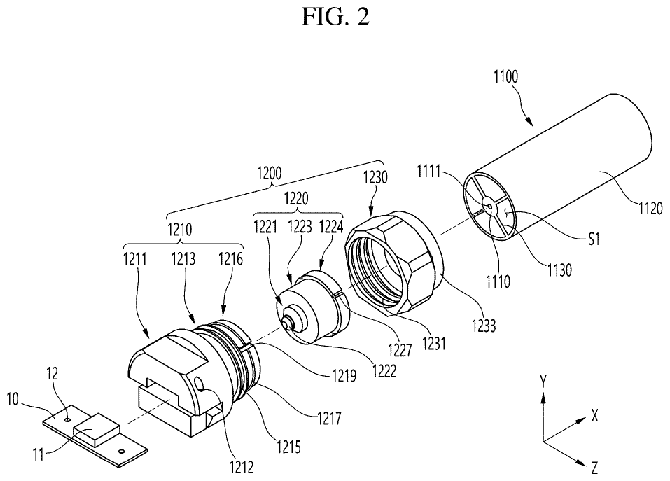

The signal line unit 1100 may transmit a wireless signal received from one side to the other side. Further, the connector 1200 may be coupled to the antenna 11 and the signal line unit 1100 and guide the wireless signal between the antenna 11 and the signal line unit 1100. This will be described below in detail with reference to FIG. 2.

FIG. 2 is an exploded perspective view of the connector and the signal line unit according to one embodiment of the present disclosure.

Various chips, electronic components, etc. may be disposed on a substrate 10. Preferably, the substrate 10 may include a semiconductor chip. For example, the substrate 10 may be a printed circuit board (PCB).

In FIG. 2, the size of the substrate 10 is illustrated small, but this is only for the sake of clarity and conciseness of the description, and the size and shape of the substrate 10 are not limited. The size of the substrate 10 may be greater than that illustrated in FIG. 2, and various electronic devices in addition to the communication device 1000 may be coupled to the substrate 10.

Referring to FIG. 2, the antenna 11 may be disposed on the substrate 10 and transmit or receive wireless signals. That is, the antenna 11 may radiate or receive wireless signals. Accordingly, the antenna 11 may radiate an electrical signal received from the substrate 10 as a wireless signal, or convert the wireless signal propagated by the antenna 11 into an electromagnetic signal and provide the converted electromagnetic signal to the substrate 10.

According to various embodiments of the present disclosure, the type and shape of the antenna 11 are not limited. For example, the antenna 11 may be a horn antenna, a Vivaldi antenna, or a patch antenna. Further, the antenna 11 may include a conductor (not illustrated) of various shapes that can radiate an electrical signal as a wireless signal, and a waveguide (not illustrated) that can allow the directivity of the radiated signal to be improved.

The antenna 11 may be fixed to the substrate 10. A method in which the antenna 11 is fixed to the substrate 10 is not limited. According to various embodiments of the present disclosure, the antenna 11 may be surface mounted on the substrate 10, or may be fixed to the substrate 10 by a separate part.

The substrate 10 and the antenna 11 may be electrically connected in various ways. For example, the substrate 10 may include a feeding line (not illustrated) that transmits an electrical signal between the substrate 10 and the antenna 11. Here, the feeding line may be disposed inside the substrate 10 or formed by being printed on the substrate 10. Further, the substrate 10 may include a feeding line of a microstrip line or a coplanar waveguide (CPWG) type, and the antenna 11 may be connected to the substrate 10 to correspond to such a feeding line.

The signal line unit 1100 may transmit a wireless signal from one side to the other side. Specifically, the signal line unit 1100 may transmit a wireless signal radiated from the antenna 11 on one side to the other side.

Referring to FIG. 2, the signal line unit 1100 may include a core 1110, a shield portion 1120, and ribs 1130. The core 1110 may have a shape extending in a longitudinal direction (x-axis direction). That is, the core 1110 may have a pipe shape. Further, cross-sections perpendicular to the longitudinal direction of the core 1110 may be the same at any position in the longitudinal direction. Further, the shape of the cross-section perpendicular to the longitudinal direction of the core 1110 may be a circular shape. According to various embodiments of the present disclosure, the shape of the core 1110 may vary. For example, the shape of the cross-section perpendicular to the longitudinal direction of the core 1110 may be a polygonal shape, and the shapes and areas of the respective cross-sections perpendicular to the longitudinal direction of the core 1110 at different positions may be different.

The core 1110 may be made of a dielectric having a predetermined permittivity. For example, the core 1110 may be made of polytetrafluoroethylene (PTFE). Accordingly, a wireless signal transmitted to one side of the core 1110 may be transmitted along the core 1110, and the wireless signal transmitted along the core 1110 may not be radiated to a material having a different permittivity, such as air, gas, vacuum, or the like outside the core 1110.

The core 1110 may be made of a flexible material having predetermined elasticity. Furthermore, the core 1110 may have a central hole 1111 in a pipe-shaped inside thereof. In this case, the core 1110 may be easily bent even with a small force. Further, the central hole 1111 may be filled with air or gas or may be in a vacuum state. In this case, since the permittivity of the dielectric forming the core 1110 and the permittivity of the material forming the central hole 1111 are different, the wireless signal transmitted along the core 1110 may be totally reflected at an interface between the core 1110 and the central hole 1111.

Referring to FIG. 2, the shield portion 1120 may have a cylindrical shape extending in the longitudinal direction in which the core 1110 extends. Further, the shield portion 1120 may be spaced apart from the core 1110 and surround the core 1110. Accordingly, the shield portion 1120 may protect the core 1110 from external impact or protect the wireless signal transmitted along the core 1110 from external electromagnetic wave signals. Accordingly, the shield portion 1120 may allow noise caused by external factors in the wireless signal transmitted along the core 1110 to be reduced.

Further, a space S1 provided between the core 1110 and the shield portion 1120 may be filled with air or gas or may be in a vacuum state. In this case, since the permittivity of the dielectric forming the core 1110 and the permittivity of the material forming the space S1 are different, the wireless signal transmitted along the core 1110 may be totally reflected at an interface between the core 1110 and the space S1. Accordingly, the wireless signal transmitted along the core 1110 may not be radiated to the outside of the signal line unit 1100.

Referring to FIG. 2, the ribs 1130 may extend in the longitudinal direction in which the core 1110 extends. Further, the ribs 1130 may extend from an outer circumferential surface of the core 1110 toward an inner circumferential surface of the shield portion 1120. Furthermore, the ribs 1130 may connect the outer circumferential surface of the core 1110 to the inner circumferential surface of the shield portion 1120. Accordingly, since a position of the core 1110 is fixed to the shield portion 1120, noise caused by the shaking of the core 1110 in the wireless signal transmitted along the core 1110 can be reduced.

The direction in which the rib 1130 extends from the outer circumferential surface of the core 1110 may be a direction in which the rib 1130 radially extends from the center of the core 1110. In this case, the outer circumferential surface of the core 1110 and the ribs 1130 may be perpendicular to each other at a portion in which the core 1110 and the ribs 1130 are in contact with each other. Further, when the shapes of cross-sections of the core 1110 and the shield portion 1120 form concentric circles, the inner circumferential surface of the shield portion 1120 and the ribs 1130 may also be perpendicular to each other at a portion in which the shield portion 1120 and the ribs 1130 are in contact with each other. In this case, the supporting force of the signal line unit 1100 itself may be strengthened. Accordingly, the signal line unit 1100 may prevent a problem of noise increasing due to the core 1110 or the shield portion 1120 being crushed or the core 1110 and the shield portion 1120 coming into contact with each other by an external force.

According to various embodiments of the present disclosure, the number of ribs 1130 may vary. The number of ribs 1130 may be determined to be minimum in order for maintaining the concentricity of the core 1110 and the shield portion 1120.

When only one rib 1130 is disposed, the number of wireless signals radiated to the outside of the signal line unit 1100 through the rib 1130 is small, and thus the transmission efficiency of the signal line unit 1100 can be improved. On the other hand, as illustrated in FIG. 2, when a plurality of ribs 1130 are disposed, the core 1110 may be stably fixed. In this case, in order to stably fix the core 1110 to the center of the signal line unit 1100 even when the signal line unit 1100 is bent in any direction, the plurality of ribs 1130 may be spaced equal intervals from each other. For example, as illustrated in FIG. 2, four ribs 1130 each may be spaced equal intervals from each other while forming an angle of 90° with a rib adjacent thereto.

Referring to FIG. 2, the direction in which the rib 1130 extends from the outer circumferential surface of the core 1110 may be different from a horizontal polarization direction or vertical polarization direction of the wireless signal propagate between the antenna 11 and the signal line unit 1100. Preferably, the direction in which the rib 1130 extends from the outer circumferential surface of the core 1110 may form an angle of 45° with respect to the horizontal polarization direction or vertical polarization direction of the wireless signal propagated between the antenna 11 and the signal line unit 1100. That is, as illustrated in FIG. 2, the cross-sections perpendicular to the longitudinal direction of the plurality of ribs 1130 may have an X-shape based on a y-z plane.

Since the wireless signal propagated between the antenna 11 and the signal line unit 1100 is an electromagnetic wave signal, horizontal polarization and vertical polarization may occur. When such a wireless signal is transmitted along the core 1110, horizontal polarization and vertical polarization that are perpendicular to each other with the core 1110 as the central axis occur. When the direction in which the rib 1130 extends from the outer circumferential surface of the core 1110 is the same as the direction of the horizontal polarization or the direction of the vertical polarization, the horizontal polarization and the vertical polarization may be radiated to the outside of the signal line unit 1100 along the rib 1130. In this case, there may be a problem that radio waves radiated from the signal line unit 1100 may cause noise in other electronic devices or that the strength of the wireless signal transmitted along the core 1110 can be reduced. Accordingly, as in the above-described embodiment, when the signal line unit 1100 and the connector 1200 are disposed so that the direction in which the rib 1130 extends from the outer circumferential surface of the core 1110 is different from the direction of the horizontal polarization and the direction of the vertical polarization, the above-described problems can be prevented.

Referring to FIG. 2, the shapes of the cross-sections of the core 1110 and the shield portion 1120 may form concentric circles. That is, the core 1110 and the shield portion 1120 may have a cylindrical shape sharing a central axis. In this case, since a distance between the outer circumferential surface of the core 1110 and the inner circumferential surface of the shield portion 1120 is radially equal, a problem of the wireless signal transmitted along the core 1110 being radiated only in a specific direction can be prevented. Further, when the signal line unit 1100 is bent in any direction, the bending strength may be the same in all directions, and the limit angle at which the core 1110 and the shield portion 1120 are in contact with each other may be the same in all directions. Accordingly, the structural stability of the signal line unit 1100 can be improved.

The core 1110, the shield portion 1120, and the ribs 1130 may be made of the same dielectric material and formed integrally. In this case, the core 1110, the shield portion 1120, and the ribs 1130 may be manufactured together through a single injection process, and thus the manufacturing time and cost of the signal line unit 1100 can be reduced. Further, the core 1110, the shield portion 1120, and the ribs 1130 may be made of a flexible material. In this case, the entire signal line unit 1100 may be easily bent, and thus the communication device 1000 may easily connect chips to chips even in a narrow space.

According to the above-described embodiment, the signal line unit 1100 transmits the wireless signal through a dielectric material and thus has a simpler structure and lower manufacturing cost than a conventional coaxial cable that transmits an electrical signal through a conductor material. Further, the signal line unit 1100 is structurally stable and resistant to external impacts, is easily bendable, and thus is easy to install in a narrow space.

Meanwhile, referring to FIG. 2, the connector 1200 is coupled to the antenna 11 that transmits or receives a wireless signal and the signal line unit 1100 that transmits a wireless signal. Accordingly, the antenna 11 and the signal line unit 1100 may be fixed by the connector 1200 and may not be shaken. Accordingly, the connector 1200 may prevent a problem of noise caused by shaking occurring in the wireless signal transmitted between the antenna 11 and the signal line unit 1100.

Referring to FIG. 2, the connector 1200 includes a connector body 1210.

Further, the connector 1200 may include an insert member 1220 and a housing 1230. The connector body 1210, the insert member 1220, and the housing 1230 may be made of the same dielectric material. Further, a portion of at least one of the connector body 1210, the insert member 1220, and the housing 1230 may be plated. Accordingly, a wireless signal radiated from the antenna 11 or signal line unit 1100 may be transmitted through an inside of the connector 1200, transmitted in a region made of a dielectric material, and reflected at a plated portion, and thus directivity can be improved.

Referring to FIG. 2, the connector body 1210 accommodates the antenna 11. In this case, in order to fix the accommodated antenna 11, the connector body 1210 may fix the substrate 10 on which the antenna 11 is disposed. For example, by passing bolts through a first bolt hole 1212 provided in the connector body 1210 and a second bolt hole 12 provided in the substrate 10, the connector body 1210 may fix the substrate 10.

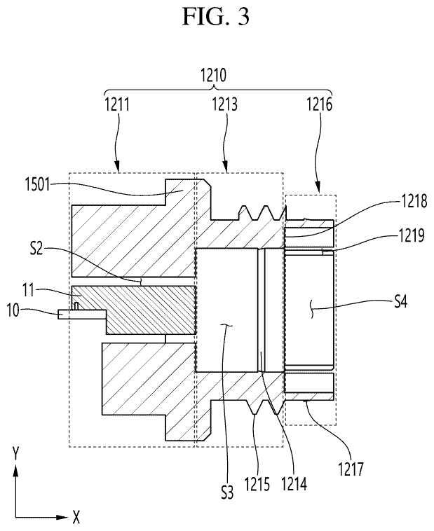

Each component included in the connector 1200 will be described below in detail with additional reference to FIGS. 3 to 5.

FIG. 3 is a cross-sectional view of the connector body that accommodates the antenna according to one embodiment of the present disclosure.

Referring to FIG. 3, the connector body 1210 includes a first sidewall portion 1211, a second sidewall portion 1213, and a third sidewall portion 1216. The first sidewall portion 1211, the second sidewall portion 1213, and the third sidewall portion 1216 may be formed integrally. Further, a space S2 surrounded by the first sidewall portion 1211, a space S3 surrounded by the second sidewall portion 1213, and a space S4 surrounded by the third sidewall portion 1216 communicate with each other.

Referring to FIG. 3, an area of a cross-section perpendicular to the longitudinal direction of the space S3 surrounded by the second sidewall portion 1213 may be greater than an area of a cross-section perpendicular to the longitudinal direction of the space S2 surrounded by the first sidewall portion 1211, and an area of a cross-section perpendicular to the longitudinal direction of the space S4 surrounded by the third sidewall portion 1216 may be greater than the area of the cross-section perpendicular to the longitudinal direction of the space S3 surrounded by the second sidewall portion 1213. However, according to various embodiments of the present disclosure, the areas of the cross-sections of the spaces S2, S3, and S4 are not limited. For example, when an area of a cross-section perpendicular to the longitudinal direction of the signal line unit 1100 is less than a certain value, the area of the cross-section perpendicular to the longitudinal direction of the space S4 may be smaller than the area of the cross-section perpendicular to the longitudinal direction of the space S3.

Referring to FIG. 3, the antenna 11 is accommodated in the space S2 surrounded by the first sidewall portion 1211. The size and shape of the space S2 may be determined to correspond to the size and shape of the antenna 11 and the size and shape of the substrate 10 coupled to the antenna 11. Further, as described above, the first sidewall portion 1211 may fix the antenna 11 accommodated in the space S2.

Referring to FIG. 3, the second sidewall portion 1213 may have a cylindrical shape extending in the longitudinal direction from a portion of an end portion of the first sidewall portion 1211. Further, the second sidewall portion 1213 surrounds the space S3 through which the wireless signal is propagated.

Referring to FIGS. 2 and 3, the wireless signal between the antenna 11 and the signal line unit 1100 is propagated through the space S3 surrounded by the second sidewall portion 1213. In this case, the second sidewall portion 1213 guides the wireless signal. Specifically, the wireless signal radiated from the antenna 11 is propagated through the space S3. In this case, since a material forming the second sidewall portion 1213 is different from a material filled in the space S3, such as air or vacuum, the wireless signal may be reflected at an inner circumferential surface of the second sidewall portion 1213. Accordingly, the wireless signal radiated from the antenna 11 may be transmitted toward the signal line unit 1100. Similarly, the wireless signal radiated from one end of the signal line unit 1100 may be propagated through the space S3, reflected at an inner side surface of the second sidewall portion 1213, and be transmitted toward the antenna 11. Accordingly, the second sidewall portion 1213 may allow the directivity of the wireless signal between the antenna 11 and the signal line unit 1100 to be improved.

Referring to FIG. 3, the second sidewall portion 1213 may include a first protrusion 1214 protruding from an inner surface of the second sidewall portion 1213 toward a central axis of the second sidewall portion 1213. Specifically, the first protrusion 1214 may protrude in a ring shape from a portion of the inner circumferential surface of the second sidewall portion 1213. Further, the first protrusion 1214 may include two inclined surfaces, and the inclination of the inclined surface at a side at which the insert member 1220 is inserted may be smaller than the inclination of the inclined surface at a side at which the antenna 11 is disposed. Accordingly, the insert member 1220, which will be described below, may be press-fitted into the space S3 surrounded by the second sidewall portion 1213 while coming into contact with the first protrusion 1214 and can be prevented from being separated from the space S3 after being disposed in the space S3.

Referring to FIG. 3, the second sidewall portion 1213 may include a second coupling portion 1215 formed on an outer side of the second sidewall portion 1213. The second coupling portion 1215 may be formed on a portion of an outer circumferential surface of the second sidewall portion 1213. Accordingly, the housing 1230, which will be described below, may be coupled to the connector body 1210 through the connection of a first coupling portion 1231 of the housing 1230 and the second coupling portion 1215.

Screw threads may be formed on the second coupling portion 1215. When screw threads corresponding to the screw threads of the second coupling portion 1215 are formed on the first coupling portion 1231 of the housing 1230, the connector body 1210 and the housing 1230 may be screwed. Accordingly, the connector 1200 may be easily and firmly assembled.

At least a portion of an inner side of the second sidewall portion 1213 may be plated with a conductor. In this case, the wireless signal propagated through the space S3 surrounded by the second sidewall portion 1213 may be shielded from other signals outside the connector 1200. Accordingly, the connector 1200 may allow noise of the wireless signal to be reduced. Further, the wireless signal transmitted in the connector 1200 may not be radiated to the outside, and thus the transmission efficiency of the wireless signal can be improved.

Referring to FIG. 3, the connector 1200 may include a handle portion 1501 that protrudes in a direction perpendicular to the longitudinal direction (x-axis direction) between the first sidewall portion 1211 and the second sidewall portion 1213. In this case, a user may hold and operate the handle portion 1501 when attaching/detaching the connector 1200 to/from the signal line unit 1100 or when attaching/detaching the connector 1200 to/from the antenna 11.

Referring to FIGS. 2 and 3, the third sidewall portion 1216 may have a cylindrical shape extending in the longitudinal direction from a portion of an end portion of the second sidewall portion 1213. The third sidewall portion 1216 may be in contact with a portion of the signal line unit 1100. A portion of the signal line unit 1100 may be inserted into the space S4 surrounded by the third sidewall portion 1216.

Referring to FIGS. 2 and 3, the third sidewall portion 1216 may include a second protrusion 1217 protruding from an outer circumferential surface of the third sidewall portion 1216 toward the outer side. Specifically, the second protrusion 1217 may protrude in a ring shape from a portion of the outer circumferential surface of the third sidewall portion 1216. Further, the second protrusion 1217 may include two inclined surfaces, and the inclination of the inclined surface at a side at which the shield portion 1120 is inserted may be smaller than the inclination of the inclined surface at a side at which the antenna 11 is disposed. Accordingly, the third sidewall portion 1216 may be press-fitted into an inner side of the shield portion 1120 so that the inner circumferential surface of the shield portion 1120 comes into contact with the second protrusion 1217, and the shield portion 1120 can be prevented from being separated from the third sidewall portion 1216. Accordingly, the signal line unit 1100 may be firmly fixed to the third sidewall portion 1216.

Referring to FIG. 3, the connector body 1210 may include a first step 1218 formed between the inner side of the second sidewall portion 1213 and an inner side of the third sidewall portion 1216. The first step 1218 may be provided because a cross-sectional area of the space S4 surrounded by the third sidewall portion 1216 is greater than a cross-sectional area of the space S3 surrounded by the second sidewall portion 1213. In this case, when the insert member 1220, which will be described below, is inserted into the space S3 surrounded by the second sidewall portion 1213, the first step 1218 and a second step 1229 provided in the insert member 1220 may be engaged so that the insert member 1220 may be fixed.

Referring to FIGS. 2 and 3, the third sidewall portion 1216 may include a second rib insertion groove 1219 that is recessed in the longitudinal direction. The number, positions, and shapes of the second rib insertion grooves 1219 may be determined to correspond to the number, positions, and shapes of the ribs 1130 disposed in the signal line unit 1100. Accordingly, the rib 1130 may be inserted into the second rib insertion groove 1219 so that a portion of the signal line unit 1100 may be inserted into the space S4 surrounded by the third sidewall portion 1216. Accordingly, the signal line unit 1100 may be firmly fixed to the third sidewall portion 1216.

According to the above-described embodiment, the connector body 1210 may be easily and firmly coupled to the antenna 11 and the signal line unit 1100. Further, the connector body 1210 may allow the directivity of the wireless signal transmitted between the antenna 11 and the signal line unit 1100 to be improved, and thus the quality and transmission efficiency of the wireless signal can be improved and noise can be reduced.

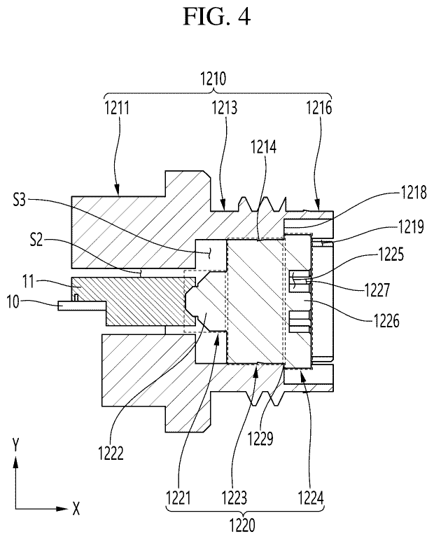

FIG. 4 is a cross-sectional view illustrating a state in which the insert member is inserted into the connector body that accommodates the antenna according to one embodiment of the present disclosure.

Referring to FIGS. 2 and 4, the insert member 1220 may guide a wireless signal between the antenna 11 and the signal line unit 1100. Specifically, the insert member 1220 may concentrate the electromagnetic energy of the wireless signal transmitted between the antenna 11 and the signal line unit 1100. For example, a wireless signal radiated from the antenna 11 may be guided by the insert member 1220 and concentrated to the core 1110. Conversely, a wireless signal radiated from the signal line unit 1100 may be guided by the insert member 1220 and concentrated to the antenna 11. Accordingly, when the insert member 1220 may be disposed in the connector 1200, the transmission efficiency of the wireless signal can be improved.

The insert member 1220 may be made of a dielectric material. Therefore, a wireless signal that is radiated from the antenna 11 and reaches the insert member 1220 or a wireless signal that is radiated from the signal line unit 1100 and reaches the insert member 1220 may be transmitted inside the insert member 1220. In this case, by adjusting the permittivity of the core 1110 and the permittivity of the insert member 1220, the impedances of the signal line unit 1100 and the connector 1200 may be matched. Accordingly, impedance matching of the communication device 1000 may be much easier than that of a coaxial cable that transmits an electrical signal using a conductor material.

The insert member 1220 may be disposed in the space S3 surrounded by the second sidewall portion 1213. Further, the insert member 1220 may be disposed between the antenna 11 and the signal line unit 1100. Further, the insert member 1220 may be inserted into the space S3 through an opening formed at one side of the connector body 1210.

The insert member 1220 may include a first structure 1221, a second structure 1223 extending in the longitudinal direction of an end portion of the first structure 1221, and a third structure 1224 extending in the longitudinal direction of an end portion of the second structure 1223. The first structure 1221, the second structure 1223, and the third structure 1224 may form the insert member 1220 as a single unit. In some cases, the first structure 1221, the second structure 1223, and the third structure 1224 may be separate components or may be coupled to each other.

The first structure 1221, the second structure 1223, and the third structure 1224 may share one central axis. In this case, the insert member 1220 may be easily inserted into the connector body 1210. Further, the insert member 1220 may be rotationally symmetrical or radially symmetrical with respect to the central axis. In this case, the wireless signal transmitted inside the insert member 1220 may be guided toward the antenna 11 or the signal line unit 1100 without distortion due to a difference in length of the transmission path.

Referring to FIGS. 3 and 4, areas of cross-sections perpendicular to the longitudinal direction of the first structure 1221, the second structure 1223, and the third structure 1224 may be determined to correspond to the areas of the cross-sections perpendicular to the longitudinal direction of spaces S2, S3, and S4. For example, as illustrated in FIG. 3, when the cross-sectional area of the space S3 is greater than the cross-sectional area of the space S2 and the cross-sectional area of the space S4 is greater than the cross-sectional area of the space S3, the area of the cross-section perpendicular to the longitudinal direction may increase from the first structure 1221 to the third structure 1224. Specifically, the area of the cross-section perpendicular to the longitudinal direction of the second structure 1223 may be greater than the area of the cross-section perpendicular to the longitudinal direction of the first structure 1221, and the area of the cross-section perpendicular to the longitudinal direction of the third structure 1224 may be greater than the area of the cross-section perpendicular to the longitudinal direction of the second structure 1223. In this case, the insert member 1220 may perform a function similar to that of a horn-shaped waveguide. Accordingly, the insert member 1220 may allow the transmission efficiency of the wireless signal radiated from the antenna 11 to be increased and allow the directivity of the wireless signal to be improved.

However, the areas of the cross-sections perpendicular to the longitudinal direction of the first structure 1221, the second structure 1223, and the third structure 1224 are not limited to that illustrated in FIG. 4. For example, when the area of the cross-section perpendicular to the longitudinal direction of the signal line unit 1100 is less than or equal to a predetermined value, the area of the cross-section perpendicular to the longitudinal direction of the third structure 1224 may be smaller than the area of the cross-section perpendicular to the longitudinal direction of the second structure 1223. In this way, the areas of the cross-sections perpendicular to the longitudinal direction of the spaces S1, S2, and S3, the first structure 1221, the second structure 1223, and the third structure 1224 may be determined in various ways according to the area of the cross-section perpendicular to the longitudinal direction of the signal line unit 1100.

Referring to FIG. 4, the first structure 1221 may include a horn shape 1222 in which an inclined portion is formed. Here, the inclined portion may be a side surface portion of the horn shape 1222. One side of the horn shape 1222 may be adjacent to the antenna 11 or come into contact with the antenna 11. Further, a portion of the horn shape 1222 may be inserted into one side of the antenna 11. For example, when the antenna 11 is a Vivaldi antenna or a horn antenna, a portion of the horn shape 1222 may be inserted into a portion of the antenna 11 from which a signal is radiated. Accordingly, the signal radiated from the antenna 11 may be accurately incident on an inside of the insert member 1220 without being lost.

Referring to FIGS. 2 and 4, an area of a cross-section perpendicular to the longitudinal direction (x-axis direction) of the horn shape 1222 may increase from a side closer to the antenna 11 to a side closer to the signal line unit 1100. In this case, the horn shape 1222 may perform the same function as a horn-shaped waveguide. Accordingly, the horn shape 1222 may allow the transmission efficiency of the wireless signal radiated from the antenna 11 to be increased and allow the directivity of the wireless signal to be improved.

Further, the horn shape 1222 may include a plurality of inclined portions and at least one step between the plurality of inclined portions. For example, as illustrated in FIG. 4, the horn shape 1222 may include two inclined portions and a step may be formed between the inclined portions. When the horn shape 1222 is inserted into the space S1 at a predetermined depth, the step may function as a locking jaw.

Further, the shape of the cross-section of the horn shape 1222 may vary. For example, the horn shape 1222 may be a cone shape, and in some cases, may be a polygonal horn shape. The shape of the cross-section of the horn shape 1222 may be determined in various ways according to the type and shape of the antenna 11, and the nature of the wireless signal radiated from the antenna 11.

However, the horn shape 1222 is not limited to those illustrated in FIGS. 2 and 4. According to various embodiments of the present disclosure, the horn shape 1222 may have various shapes. For example, the area of the cross-section perpendicular to the longitudinal direction (x-axis direction) of the horn shape 1222 may decrease from the side closer to the antenna 11 to the side closer to the signal line unit 1100. Alternatively, the horn shape 1222 may include all sections that become wider and sections that become narrower as it gets closer to the signal line unit 1100. In this way, the horn shape 1222 may have various shapes according to the area of the cross-section perpendicular to the longitudinal direction of the signal line unit 1100.

Referring to FIG. 4, the second structure 1223 may be in contact with the first protrusion 1214 protruding from the inner surface of the second sidewall portion 1213 toward the second structure 1223. Accordingly, the insert member 1220 may be press-fitted into the space S3 by frictional force with the first protrusion 1214, and the first protrusion 1214 may prevent the insert member 1220 from being separated.

Referring to FIGS. 2 and 4, the third structure 1224 is an assembly part with the signal line unit 1100 and may prevent discontinuity of radio frequency (RF) characteristics occurring between the insert member 1220 and the core 1110. Accordingly, the third structure 1224 may allow the uniformity of RF characteristics of the wireless signal to be improved.

Referring to FIGS. 2 and 4, the third structure 1224 may include a core insertion groove 1225 formed in a central region of one surface of the third structure 1224. Here, one surface of the third structure 1224 is a surface of a side close to the signal line unit 1100. Further, the central region may be determined according to the area of the cross-section perpendicular to the longitudinal direction of the core 1110 and the shape of the core 1110. A portion of the core 1110 may be inserted into the core insertion groove 1225. Accordingly, the signal line unit 1100 may be fixed to the insert member 1220, and the connector 1200 may prevent noise from occurring due to movement of the signal line unit 1100.

Referring to FIGS. 2 and 4, the third structure 1224 may include a core insertion protrusion 1226 protruding from the center of the core insertion groove 1225. The core insertion protrusion 1226 may protrude in the longitudinal direction. The core insertion protrusion 1226 may be inserted into the central hole 1111 formed inside the core 1110. Accordingly, the signal line unit 1100 may be easily bent and be more firmly fixed to the connector 1200.

Referring to FIGS. 2 and 4, the third structure 1224 may include at least one first rib insertion groove 1227 that is radially recessed from the center of one surface of the third structure 1224. For example, the first rib insertion groove 1227 may have a shape that is radially recessed from the core insertion protrusion 1226. Here, the radially recessed shape means a shape that is recessed in a direction perpendicular to the longitudinal direction (x-axis direction). The rib 1130 may be inserted into the first rib insertion groove 1227. The number and shapes of the first rib insertion grooves 1227 may correspond to the number and shapes of the ribs 1130.

Accordingly, the signal line unit 1100 may be fixed to the connector 1200 so as not to rotate.

Referring to FIG. 4, the insert member 1220 may include the second step 1229 formed between the second structure 1223 and the third structure 1224. The second step 1229 may be a portion formed because the area of the cross-section perpendicular to the longitudinal direction of each of the second structure 1223 and the third structure 1224 are different. When the insert member 1220 is inserted into the connector body 1210, the second step 1229 may function as a locking jaw by being engaged with the first step 1218.

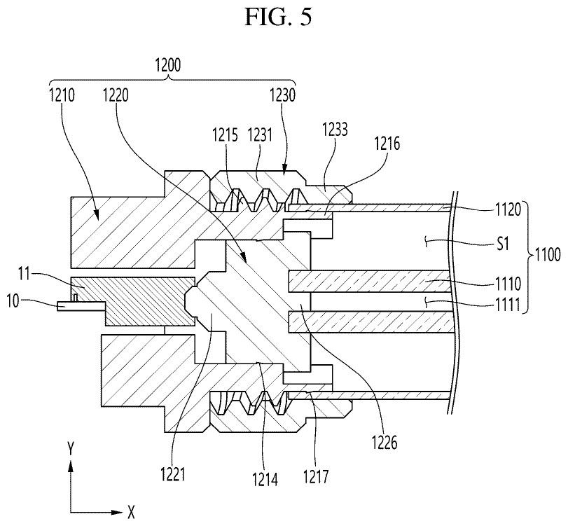

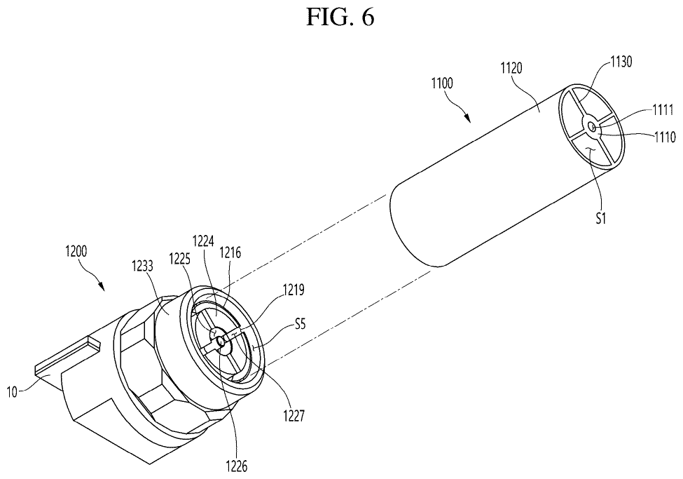

The specific shape of the first rib insertion groove 1227 and its coupling relationship with the signal line unit 1100 will be described below with reference to FIGS. 5 and 6.

FIG. 5 is a cross-sectional view illustrating a state in which the antenna is accommodated in the connector and the signal line unit is inserted into the connector according to one embodiment of the present disclosure.

Referring to FIG. 5, the housing 1230 may be coupled to the connector body 1210. The housing 1230 may more firmly fix the signal line unit 1100 coupled to the connector body 1210 and protect a portion in which the connector body 1210 and the signal line unit 1100 are coupled.

Referring to FIG. 5, the housing 1230 may include the first coupling portion 1231 and a shield portion fixing portion 1233. The first coupling portion 1231 may be formed on an inner circumferential surface of the housing 1230. The first coupling portion 1231 may be coupled to the second coupling portion 1215 formed on the outer side of the second sidewall portion 1213. For example, the first coupling portion 1231 and the second coupling portion 1215 may include screw threads corresponding thereto, and the screw threads may be screwed with each other. Accordingly, the housing 1230 may be firmly fixed to the connector body 1210.

Referring to FIG. 5, the shield portion fixing portion 1233 may more firmly fix the shield portion 1120. A portion of the shield portion 1120 may be disposed in a space formed between the third sidewall portion 1216 and the shield portion fixing portion 1233. Accordingly, an outer surface of the shield portion 1120 may come into contact with an inner surface of the shield portion fixing portion 1233, and the inner surface of the shield portion 1120 may come into contact with an outer surface of the third sidewall portion 1216. That is, the shield portion 1120 may be fitted into a space formed between the third sidewall portion 1216 and the shield portion fixing portion 1233. Furthermore, the second protrusion 1217 may prevent the shield portion 1120 from being separated between the third sidewall portion 1216 and the shield portion fixing portion 1233.

As described above, the connector 1200 may include the connector body 1210 that provides the space S3 through which a wireless signal is propagated, the insert member 1220 for improving the gain and directivity of the wireless signal, and the housing 1230 that protects and fixes a portion in which the connector body 1210 and the signal line unit 1100 are coupled. Accordingly, the connector 1200 may further include the housing 1230, and thus distortion, noise, and loss rate of the wireless signal transmitted between the antenna 11 and the signal line unit 1100 can be reduced, and the gain and directivity of the wireless signal can be improved.

Further, each component of the connector 1200 may be coupled to at least some components of the signal line unit 1100, and thus the connector 1200 may prevent rotation or movement of the signal line unit 1100. Accordingly, the communication device 1000 may provide the above-described advantages of the signal line unit 1100, and prevent degradation of the quality of the wireless signal due to the rotation or movement of the signal line unit 1100. Furthermore, the connector 1200 may be easy to assemble and also easy to be coupled to the signal line unit 1100, and thus the communication device 1000 may be easy to assemble.

FIG. 6 is a perspective view for describing a connection of a connector and a signal line unit according to one embodiment of the present disclosure.

Referring to FIG. 6, the core 1110 may be inserted into the core insertion groove 1225, and the core insertion protrusion 1226 may be inserted into the central hole 1111 formed in the core 1110.

Referring to FIG. 6, the shield portion 1120 may be inserted into a space S5 between the shield portion fixing portion 1233 and the third sidewall portion 1216.

Referring to FIG. 6, the ribs 1130 may be inserted into the first rib insertion groove 1227 and the second rib insertion groove 1219. In this case, the first rib insertion groove 1227 and the second rib insertion groove 1219 may be positioned on the same line. Specifically, the first rib insertion groove 1227 may be positioned at a position extending along the second rib insertion groove 1219 based on a central axis of the insert member 1220. To this end, the insert member 1220 may rotate at a predetermined angle when inserted into the connector body 1210. According to such a structure, since the ribs 1130 are simultaneously inserted into both the first rib insertion groove 1227 and the second rib insertion groove 1219, rotation of the connector body 1210 and the insert member 1220 can be prevented.

In this way, one side surface of the connector 1200 may have a shape corresponding to a cross-section of the signal line unit 1100, and each of the core 1110, the shield portion 1120, and the ribs 1130 may be inserted into one side surface of the connector 1200.

Meanwhile, the order of assembling the communication device 1000 according to various embodiments of the present disclosure is not limited. For example, the communication device 1000 may be assembled by assembling all the components of the connector 1200 and then inserting the signal line unit 1100 into the connector 1200. Alternatively, as illustrated in FIG. 4, the communication device 1000 may be assembled by inserting the insert member 1220 into the connector body 1210, then coupling the signal line unit 1100 to the connector body 1210 and the insert member 1220, and then coupling the housing 1230 to the connector body 1210. For such an assembly process, the housing 1230 may be placed over the signal line unit 1100 before the insert member 1220 is inserted into the connector body 1210.

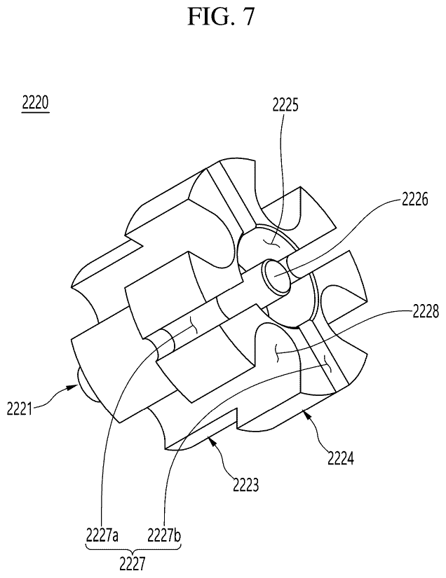

FIG. 7 is a perspective view of an insert member according to another embodiment of the present disclosure.

Referring to FIG. 7, an insert member 2220 may include through-holes 2228 to match the RF characteristics of a wireless signal. The number of through-holes 2228 may be determined in various ways according to the RF characteristics of the wireless signal. For example, the through-holes 2228 may be disposed one by one between first rib insertion grooves 2227a and 2227b. Accordingly, when the number of first rib insertion grooves 2227 is four, the number of through-holes 2228 may be four.

The through-holes 2228 may pass through a second structure 2223 and a third structure 2224 in a longitudinal direction. The through-holes 2228 may be disposed to be spaced a predetermined interval or more from a central axis of the insert member 2220. Here, the predetermined interval may have various values. For example, as illustrated in FIG. 7, the through-holes 2228 may be disposed to be spaced a radius or more of a cross-section perpendicular to the longitudinal direction of a first structure 2221 from each other. In this case, the through-holes 2228 may not be disposed in the first structure 2221. Further, the through-holes 2228 may have a shape that is recessed from an inside of each of the second structure 2223 and the third structure 2224 to an outer circumferential surface of each of the second structure 2223 and the third structure 2224.

The through-holes 2228 may not be disposed in a portion in which the insert member 2220 and the signal line unit 1100 are coupled. That is, the through-holes 2228 may not be disposed in a core insertion groove 2225, a core insertion protrusion 2226, and a first rib insertion groove 2227. Accordingly, the insert member 2220 may firmly maintain the coupling with the rib 1130 and at the same time, may allow the RF characteristics of the wireless signal to be improved.

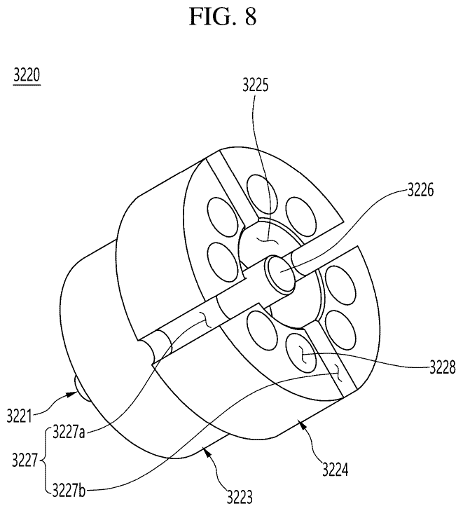

FIG. 8 is a perspective view of an insert member according to still another embodiment of the present disclosure.

Referring to FIG. 8, through-holes 3228 may be disposed in pairs between adjacent first rib insertion grooves 3227a and 3227b. Accordingly, when the number of first rib insertion grooves 3227 is four, the number of through-holes 3228 may be eight. An area of each of the through-holes 3228 illustrated in FIG. 8 may be smaller than an area of each of the through-holes 2228 illustrated in FIG. 7.

The through-holes 3228 may be disposed only inside each of a second structure 3223 and a third structure 3224, and may not be exposed on outer circumferential surfaces of the second structure 3223 and the third structure 3224. Accordingly, the structural stability of the insert member 3220 can be improved.

The insert members 2220 and 3220 according to FIGS. 7 and 8 include through-holes of various shapes and numbers, and thus it is possible to guide wireless signals transmitted from an antenna of a communication device to be more concentrated on a signal line unit, or to guide wireless signals transmitted from a signal line unit to be more concentrated on an antenna.

According to one of the solutions of the present disclosure, a connector can guide wireless signals between an antenna and a signal line unit by providing a space through which the wireless signals are propagated.

According to one of the solutions of the present disclosure, a connector body, an insert member, and a housing are easily coupled, and thus a connector can be easily assembled.

According to one of the solutions of the present disclosure, an insert member is disposed inside a connector body, and thus a connector can allow the transmission efficiency of wireless signals transmitted between an antenna and a signal line unit to be increased.

According to one of the solutions of the present disclosure, by coupling each of components of a connector to a signal line unit, the connector can prevent rotation or movement of the signal line unit.

While embodiments of the present disclosure have been described in more detail with reference to the accompanying drawings, the present disclosure is not necessarily limited to these embodiments, and various modifications may be made in the present disclosure without departing from the spirit and scope of the present disclosure. Accordingly, the embodiments disclosed in the present disclosure are not intended to limit the technical idea of the present disclosure but to explain it, and the scope of the technical idea of the present disclosure is not limited by these embodiments. Therefore, it should be understood that the above-described embodiments are exemplary in all respects and not restrictive. The scope of the present disclosure should be interpreted by the appended claims and encompasses all modifications and equivalents that fall within the scope of the appended claims.

What is claimed is:

1. A connector which is coupled to an antenna for transmitting or receiving a wireless signal and a signal line unit for transmitting the wireless signal, the connector comprising a connector body including a first sidewall portion, a second sidewall portion, and a third sidewall portion,
wherein the first sidewall portion surrounds a space that accommodates the antenna,
the second sidewall portion guides the wireless signal propagated between the antenna and the signal line unit,
the third sidewall portion is in contact with a portion of the signal line unit, and
spaces surrounded by each of the first sidewall portion, the second sidewall portion, and the third sidewall portion communicate with each other.

2. The connector of claim 1, wherein the signal line unit includes:
a core that extends in a longitudinal direction;
a shield portion that is spaced apart from the core, surrounds the core, and extends in the longitudinal direction; and
at least one rib that extends from an outer circumferential surface of the core toward an inner circumferential surface of the shield portion.

3. The connector of claim 2, wherein the third sidewall portion includes at least one second rib insertion groove that is recessed in the longitudinal direction, and
at least a portion of the at least one rib is inserted into the at least one second rib insertion groove.

4. The connector of claim 2, further comprising an insert member disposed in the space surrounded by the second sidewall portion,
wherein the insert member includes:
a first structure including a horn shape on which at least one inclined portion is formed;
a second structure that extends in the longitudinal direction from an end portion of the first structure; and
a third structure that extends in the longitudinal direction from an end portion of the second structure, and
the first structure, the second structure, and the third structure share a central axis.

5. The connector of claim 4, wherein the second sidewall portion includes a first protrusion that protrudes from an inner surface of the second sidewall portion toward the second structure.

6. The connector of claim 4, wherein the third structure includes a core insertion groove formed in a central region of one surface of the third structure, and
a portion of the core is inserted into the core insertion groove.

7. The connector of claim 6, wherein the third structure includes a core insertion protrusion that protrudes from a center of the core insertion groove, and
the core insertion protrusion is inserted into a central hole inside the core formed in the longitudinal direction.

8. The connector of claim 4, wherein the third structure includes at least one first rib insertion groove that is radially recessed from a center of one surface of the third structure, and
at least a portion of the at least one rib is inserted into the at least one first rib insertion groove.

9. The connector of claim 4, wherein the second structure and the third structure include a plurality of through-holes formed to pass therethrough in the longitudinal direction, and
the plurality of through-holes are spaced a predetermined interval or more from a central axis of the insert member and radially disposed based on the central axis of the insert member.

10. The connector of claim 4, wherein the connector body includes a first step formed between the second sidewall portion and the third sidewall portion, and
the insert member includes a second step that is formed between the second structure and the third structure and corresponds to the first step.

11. The connector of claim 2, further comprising a housing coupled to the connector body,
wherein the housing includes:
a first coupling portion formed on an inner circumferential surface of the housing; and
a shield portion fixing portion that extends in the longitudinal direction from the first coupling portion.

12. The connector of claim 11, wherein the second sidewall portion includes a second coupling portion formed on an outer side of the second sidewall portion, and
the first coupling portion and the second coupling portion include screw threads corresponding to each other.

13. The connector of claim 12, wherein the third sidewall portion includes a second protrusion that protrudes from an outer circumferential surface of the third sidewall portion toward the signal line unit, and
a portion of the shield portion is disposed in a space formed between the third sidewall portion and the shield portion fixing portion.

14. The connector of claim 2, wherein a direction in which the at least one rib extends from the outer circumferential surface of the core forms an angle of 45° with respect to a horizontal polarization direction or vertical polarization direction of the wireless signal propagated between the antenna and the signal line unit.
